(19) United States
(12) Patent Application Publication
(10) Pub. No.: US 2012/0074701 A1
(43) Pub. Date: Mar. 29, 2012

(54) RIDGE CAP WIND GENERATION SYSTEM

(76) Inventors: Frank Hernandez, Pompeys Pillar, MT (US); Wendy Hernandez, Pompey Pillar, MT (US)

(21) Appl. No.: 12/889,441

(22) Filed: Sep. 24, 2010

(51) Int. Cl. F03D 9/00; F03D 9/02

(52) U.S. Cl. 290/50; 290/55; 290/52

(57) ABSTRACT

A wind generating system for a residential home comprising: at least one mounting plate; a plurality of wind turbines mounted on the at least one mounting plate; a riser, where said riser supports the mounting plate; and a tubing, where said tubing attaches to a ridge cap of a roof and said riser attaches to the tubing. The turbines generate electrical energy for the residential home and each turbine is mounted on a motor housing. In one particular embodiment, the mounting plates extend the entire length of the ridge cap.

### BACKGROUND OF THE INVENTION

1. Field of Invention

The present invention relates to a wind generation system for residential homes.

2. Description of Related Art

Mounting energy costs presently associated with petroleum products has spawned the development of alternative energy generating systems. Alternative energy sources exclude the use of fossil fuels, such as oil, gas or natural gas, and nuclear energy both of which are widely used and a source of not only high costs but produce high carbon dioxide emissions. Higher carbon dioxide missions have been linked to global warming and consequential environmental concerns.

A significant amount of focus has been placed on renewable sources of energy such as sunlight, wind, rain, tides and geothermal heat. These sources of energy are naturally replenished. Further these sources of energy may be captured fairly easily as opposed to the drilling and processing associated with fossil fuels. One particular source of renewable energy is wind-generated energy. Wind may be converted to energy through the use of wind turbines, where wind turbines are placed in either open fields or the ocean where floating turbines have been placed. The use of wind turbines and wind-generated energy has increase in capacity and usage over the recent years. Wind power may be generated on a small scale where wind turbines may be utilized to provide energy for a small facility or a small community; or larger wind turbine farms have been also developed which provide energy for a larger grid of service.

The cost of wind-generated energy has also been decreasing over the recent years due to the increased technology related to wind turbines and wind farms. Although the initial cost for building and creating wind turbine generating systems is significant, the benefits over the long haul definitely outweigh the initial costs. The environmental effects of wind power are relatively minor whereas the wind power doesn't consume any fuel, emit air pollution or generate carbon dioxide emissions.

Consequently wind power appears to be a very conducive and desirable alternative of generating power. It also would be advantageous to install individual wind generating systems for residential homes in order to eliminate the need for consumption off a traditional power grid. Such an individual wind generating system would have advantages as discussed above with wind generated power and have a direct cost savings to many consumers.

### SUMMARY OF THE INVENTION

The present invention relates to a wind generating system for a residential home comprising: at least one mounting plate; a plurality of wind turbines mounted on the at least one mounting plate; a riser, where said riser supports the mounting plate; and a tubing, where said tubing attaches to a ridge cap of a roof and said riser attaches to the tubing. The turbines generate electrical energy for the residential home and each turbine is mounted on a motor housing. In one particular embodiment, the mounting plates extend the entire length of the ridge cap.

### DESCRIPTION OF DRAWINGS

FIG. 1 depicts a wind generating system according to the present invention.

FIG. 2 provides a side view of the wind generating system mounted on a ridge cap of a residential home.

FIG. 3 provides a top view of a mounting plate associated with the wind generating system according to the present invention.

### DETAILED DESCRIPTION

The present invention provides an alternative energy generating system that utilizes wind power to generate energy for a residential home. The wind generating system according to the present invention efficiently supplies wind power for a household and provides an alternative source of energy from a replenishable source. The wind generating systems according to the present invention are designed to assist the domestic consumer in providing energy and reducing costs associated with the use of traditional sources of energy such a fossil fuel.

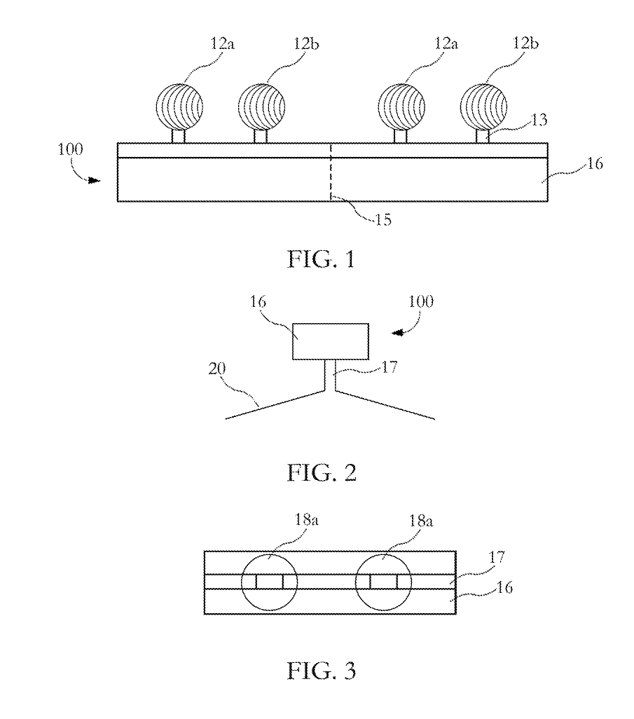

FIG. 1 depicts a Wind Generating System 100 according to the present invention. As shown, the Wind Generating System 100 includes a plurality of wind turbines placed upon a Mounting Plate 16. The wind turbines 12a, 12b are shown on two mounting plates that are adjoined at a centerline 15. The uniqueness of the Wind Generating System 100 according to the present invention is the ability to provide multiple wind turbines along a ridge cap of a residential home. Multiple mounting plates may be abutted and therefore increase the wind turbine capacity as needed for the size and consumption associated with a household. The wind turbines are each mounted upon a Motor Housing 13, which is utilized to generate the electricity or energy needed for the household.

In one exemplary embodiment of the present invention, the Mounting Plates 16 may be sized at about four feet in length and provide sufficient space for the mounting of two wind turbines 12a, 12b as depicted in FIG. 1. The only limitation in terms of the number of wind turbines is the length of the ridge cap that provides the means for mounting the mounting plate housing onto the roof of the residence. The Wind Generating System 100 includes a wiring scheme that is similar to a conventional wiring scheme where the energy generated is throughout the house through a circuit breaker that receives the electrical energy generated by the wind turbines. A portion of the energy generated by the wind turbines may be stored in a battery bank and therefore provide a backup system of stored energy to assist in an even distribution of energy throughout the household over a period of time.

The wind turbines 12a, 12b as depicted in FIG. 1 may have a dome or ball shape so that the wind may be captured from any direction. The wind generating system therefore provides a very efficient and effective alternative for the residential home. FIG. 2 depicts a side view of the Mounting Plate 16 of the Wind Generating System 100. As noted the Mounting Plate 16 includes a Riser 17, which supports the mounting plate 16. The mounting plates are mounted upon the ridge cap of a Roof 20 as shown in FIG. 2.

FIG. 3 provides a top view of the Mounting Plate 16 without the insertion of wind turbines 12a, 12b. As shown two mounting holes 18a, 18b are provided for the insertion of wind turbines 12a, 12b. The top of the Riser 17 is also shown as running along the center of the Mounting Plate 16. As stated above in one exemplary embodiment, the Mounting Plate 16 may be about 4 feet in length and 15 inches wide and shaped to be mounted upon a ridge cap. The risers may be 2 inches in thickness and connected to a 2×4 inch square tubing where the tubing may be mounted directly to the ridge cap of the roof.

The wind generating system according to present invention is therefore designed for the domestic or residential consumer and may be easily mounted upon a roof of a home. Although the wind generating system as shown in the present invention is shown to be mounted upon a ridge cap, the wind generating system may also be configured with appropriate mounting support to be placed upon a flat roof or a roof that lacks a ridge cap as depicted in FIG. 2. Furthermore the Wind Generating System 100 provides the consumer with the flexibility of adding additional wind turbines as needed based upon an increased energy need or desired capacity.

What is claimed is:

1. A wind generating system for a residential home comprising:
a. at least one mounting plate;
b. a plurality of wind turbines mounted on the at least one mounting plate;
c. a riser, where said riser supports the mounting plate; and
d. a tubing, where said tubing attaches to a ridge cap of a roof and said riser attaches to the tubing.

2. The wind generating system according to claim 1, where the said turbines generate electrical energy.

3. The wind generating system according to claim 2, where each turbine is mounted on a motor housing.

4. The wind generating system according to claim 1, where the mounting plates extend the entire length of the ridge cap.

5. The wind generating system according to claim 1, where said system includes a wiring scheme for the transmission of electrical energy generated by the system.

6. The wind generating system according to claim 1, where a portion of the energy generated by the wind turbines is stored in a battery bank.
